(19) United States
(12) Patent Application Publication
(10) Pub. No.: US 2014/0035964 A1
(43) Pub. Date: Feb. 6, 2014

(54) LIGHTING SYSTEM, LIGHTING METHOD, AND LIGHTING PROGRAM

(71) Applicant: SEIKO EPSON CORPORATION, Tokyo (JP)

(72) Inventor: Hirofumi KASUGA, Matsumoto-shi (JP)

(73) Assignee: SEIKO EPSON CORPORATION, Tokyo (JP)

(21) Appl. No.: 13/950,549

(22) Filed: Jul. 25, 2013

(30) Foreign Application Priority Data
Aug. 1, 2012 (JP) 2012-170884

(51) Int. Cl. G09G 3/22

(52) U.S. Cl. CPC G09G 3/22
USPC 345/690

(57) ABSTRACT

A lighting system includes a master set and a plurality of lighting devices controlled by the master set. At least one of the plurality of lighting devices is a bulb-type lighting device having a lighting function and an image displaying function and including a light source for lighting and a light source for image display provided in common or separately, an image forming unit configured to modulate light from the light source for image display on the basis of image information for image display and form image light, a lens configured to project the image light formed by the image forming unit on a projection surface, and a connecting unit electrically connectable to a lighting device fitting.

The entire disclosure of Japanese Patent Application No. 2012-170884, filed Aug. 1, 2012 is expressly incorporated by reference herein.

### BACKGROUND

1. Technical Field

The present invention relates to a lighting system, a lighting method, and a lighting program.

2. Related Art

There is known a lighting system including a plurality of lighting fixtures set in a lighting space, a lighting controller configured to subject the plurality of lighting fixtures to dimming control for each scene, and a remote controller configured to perform scene setting for the lighting controller (see JP-A-2009-238399 (Patent Literature 1)).

In the lighting system, the lighting controller includes an image pickup unit configured to pickup an image of the lighting space, a calculating unit configured to detect a plurality of positions of the remote controller from the image picked up by the image pickup unit and set a scene area for reproducing a scene, a storing unit configured to store scene data originated by the remote controller according to the scene area, a control unit configured to generate, on the basis of the scene data, a lighting control signal for performing lighting control of the lighting fixtures, and a dimming-signal output unit configured to output a dimming signal to the lighting fixtures on the basis of the lighting control signal. When the control unit detects from the image picked up by the image pickup unit that a person is present in the set scene area, the control unit generates the lighting control signal on the basis of the scene data corresponding to the scene area.

However, in such a lighting system, it is necessary to pick up an image every time to find where a person is present, which takes labor and time.

There is known a light controller that subjects brightness of a plurality of lighting loads arranged in a lighting space to dimming control (see JP-A-2009-224220 (Patent Literature 2)).

In the light controller, the plurality of lighting loads are divided into two circuits. The light controller includes an image-point selecting unit configured to select a desired image point from an image of the lighting space two-dimensionally represented and set in advance, an image-point displaying unit configured to display the selected image point, a dimming-signal control unit configured to control a dimming signal output to the lighting loads, which are respectively connected to the two circuits, in a range of a dimming level at the selected image point in a range of a dimming level set for each of the two circuits according to the image of the lighting space in advance, and a dimming-signal outputting unit configured to output the controlled dimming signal.

With such a light controller, for example, it is possible to change brightness according to a mood of a user in a living room and easily enjoy spatial presentation.

However, in the related arts disclosed in Patent Literatures 1 and 2, although adjustment of lighting is performed, there is no disclosure concerning spatial presentation including an image.

For example, in recent years, an extremely large number of image apparatuses have been introduced to a home electronics market. Specifically, there are a large number of image apparatuses including a television (TV), a personal computer, a portable terminal such as a tablet computer, a cellular phone, a digital still camera, and a digital camcorder. There are an increasing number of people who desire to enjoy images obtained from these image apparatuses in various places and in various scenes (e.g., one person watches images quietly, many people watch images clamorously, and people watch images in a calm atmosphere).

### SUMMARY

An advantage of some aspects of the invention is to provide a lighting system, a lighting method, and a lighting program that can control a plurality of lighting devices including at least one bulb-type lighting device having both of a lighting function and an image displaying function.

An aspect of the invention is directed to a lighting system including: a master set; and a plurality of lighting devices controlled by the master set. At least one of the plurality of lighting devices is a bulb-type lighting device having a lighting function and an image displaying function and including: a light source for lighting and a light source for image display provided in common or separately; an image forming unit configured to modulate light from the light source for image display on the basis of image information for image display and form image light; a lens configured to project the image light formed by the image forming unit on a projection surface; and a connecting unit electrically connectable to a lighting device fitting.

With this configuration, the master set controls the plurality of lighting devices, at least one of which is the bulb-type lighting device having the lighting function and the image displaying function as explained above. Consequently, the lighting system can control the plurality of lighting devices including at least one bulb-type lighting device having both of the lighting function and the image displaying function.

Another aspect of the invention is directed to the lighting system, wherein the master set includes: a scene-data storing unit configured to store, for each of a plurality of scenes, scene data that is data for defining a condition concerning lighting irradiation and a condition concerning image display in each of the plurality of lighting devices; a scene operation unit operated by a user to receive designation of any one scene among the plurality of scenes; and a control unit configured to control each of the plurality of lighting devices on the basis of the condition concerning the lighting irradiation and the condition concerning the image display defined by the scene data stored in the scene-data storing unit in association with the scene designated by the scene operation unit.

With this configuration, in the master set, the scene-data storing unit stores the scene data for each of the plurality of scenes. The control unit controls the lighting irradiation and the image display in each of the plurality of lighting devices on the basis of the scene data corresponding to the scene designated by the scene operation unit operated by the user. Consequently, the lighting system can effectively control the plurality of lighting devices including at least one bulb-type lighting device having both of the lighting function and the image displaying function.

Still another aspect of the invention is directed to the lighting system, wherein the master set includes a setting unit operated by a user to set, for each of a plurality of scenes, a condition concerning lighting irradiation and a condition concerning image display in each of the plurality of lighting devices defined by scene data that is data for defining a condition concerning lighting irradiation and a condition concerning image display in each of the plurality of lighting devices.

With this configuration, in the master set, the setting unit is operated by the user to set, for each of the plurality of scenes, the condition concerning the lighting irradiation and the condition concerning the image display in each of the plurality of lighting devices. Consequently, the lighting system can set, for each of the plurality of scenes, the condition concerning the lighting irradiation and the condition concerning the image display according to a preference or the like of the user and can effectively control the plurality of lighting devices including at least one bulb-type lighting device having both of the lighting function and the image displaying function.

Yet another aspect of the invention is directed to the lighting system, wherein the master set includes a lighting/image selecting unit operated by a user to select any one of only lighting, only an image, and a link of lighting and an image, and the control unit controls the plurality of lighting devices to execute only lighting irradiation when the only lighting is selected by the lighting/image selecting unit, controls the plurality of lighting devices to execute only image display when the only an image is selected by the lighting/image selecting unit, and controls the plurality of lighting devices to execute the lighting irradiation and the image display when the link of lighting and an image is selected by the lighting/image selecting unit.

With this configuration, in the master set, the lighting/image selecting unit is operated by the user to select any one of only lighting, only an image, and a link of lighting and an image. The control unit controls each of the plurality of lighting devices according to selected one of the only lighting, the only an image, and the link of lighting and an image. Consequently, the lighting system can effectively control the plurality of lighting devices including at least one bulb-type lighting device having both of the lighting function and the image displaying function.

Still yet another aspect of the invention is directed to a lighting method including a master set controlling a plurality of lighting devices, at least one of which is a bulb-type lighting device having a lighting function and an image displaying function and including a light source for lighting and a light source for image display provided in common or separately, an image forming unit configured to modulate light from the light source for image display on the basis of image information for image display and form image light, a lens configured to project the image light formed by the image forming unit on a projection surface, and a connecting unit electrically connectable to a lighting device fitting.

With this method, the master set controls the plurality of lighting devices, at least one of which is the bulb-type lighting device having the lighting function and the image displaying function as explained above. Consequently, the lighting system can control the plurality of lighting devices including at least one bulb-type lighting device having both of the lighting function and the image displaying function.

Further another aspect of the invention is directed to a lighting program for causing a computer to execute a procedure of a master set for controlling a plurality of lighting devices, at least one of which is a bulb-type lighting device having a lighting function and an image displaying function and including a light source for lighting and a light source for image display provided in common or separately, an image forming unit configured to modulate light from the light source for image display on the basis of image information for image display and form image light, a lens configured to project the image light formed by the image forming unit on a projection surface, and a connecting unit electrically connectable to a lighting device fitting.

With this program, the master set controls the plurality of lighting devices, at least one of which is the bulb-type lighting device having the lighting function and the image displaying function as explained above. Consequently, the lighting system can control the plurality of lighting devices including at least one bulb-type lighting device having both of the lighting function and the image displaying function.

As explained above, according to the aspects of the invention, the master set controls the plurality of lighting devices, at least one of which is the bulb-type lighting device having the lighting function and the image displaying function as explained above. Consequently, the lighting system can control the plurality of lighting devices including at least one bulb-type lighting device having both of the lighting function and the image displaying function.

### BRIEF DESCRIPTION OF THE DRAWINGS

The invention will be described with reference to the accompanying drawings, wherein like numbers reference like elements.

FIG. 1 is a block diagram showing a schematic configuration example of a lighting system according to an embodiment of the invention.

FIG. 2 is a block diagram showing a schematic configuration example of a master set according to the embodiment of the invention.

FIG. 3 is a diagram showing a schematic configuration example of a changeover switch included in a lighting/image selecting unit according to the embodiment of the invention.

FIG. 4 is a flowchart for explaining a procedure of processing for performing scene setting in the master set according to the embodiment of the invention.

FIG. 5 is a diagram schematically showing a configuration of a bulb-type lighting device including both of a lighting function and an image displaying function (in this example, an image projecting function).

FIG. 6 is a diagram schematically showing a configuration example of an optical system related to image projection of the bulb-type lighting device having both of the lighting function and the image displaying function (in this example, the image projecting function).

FIG. 7 is a flowchart for explaining an example of a procedure of processing performed in the bulb-type lighting device having both of the lighting function and the image displaying function (in this example, the image projecting function).

### DESCRIPTION OF EXEMPLARY EMBODIMENTS

An embodiment of the invention is explained in detail with reference to the accompanying drawings.

In this specification, an image is a concept including a moving image and a still image. A video represents a moving image.

When the same result is obtained by processing a moving image (a video) and by processing an image frame (a still image) included in the moving image (the video), arbitrary one of these kinds of processing may be used or a configuration in which the kinds of processing are interchanged may be used.

### Explanation of a Lighting System

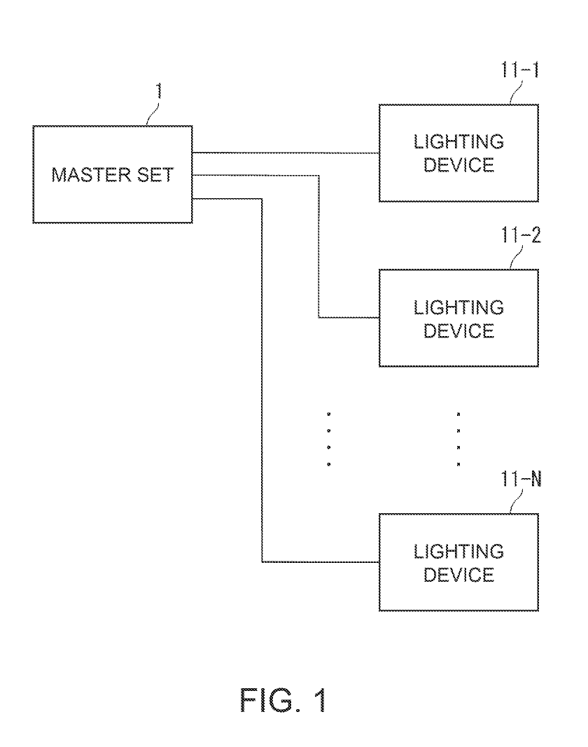

FIG. 1 is a block diagram showing a schematic configuration example of a lighting system according to the embodiment of the invention.

The lighting system according to this embodiment includes a master set 1 and a plurality of (in this embodiment, a plural number N) lighting devices 11-1 to 11-N.

The master set 1 and the lighting devices 11-1 to 11-N are respectively connected via wired lines. Wireless lines may be used instead of the wired lines or together with the wired lines.

The plurality of lighting devices 11-1 to 11-N are arranged to perform lighting irradiation and image display in a space (a lighting space) in which provision of a scene (in this embodiment, the lighting irradiation and the image display) is performed.

In this embodiment, at least one of the plurality of lighting devices 11-1 to 11-N is a bulb-type lighting devices (lighting fixtures) having both of a lighting function (a function of a lighting fixture) and an image displaying function (a function of an image display apparatus).

Except when all the plurality of lighting devices 11-1 to 11-N are bulb-type lighting devices having both of the lighting function and the image displaying function, as the other lighting devices, various lighting devices may be used. For example, a lighting device (not of the bulb-type) having both of the lighting function and the image displaying function may be used or a lighting device having only the lighting function may be used.

As the image displaying function, for example, a function of an extremely small device (a function of a pico-projector) can be used.

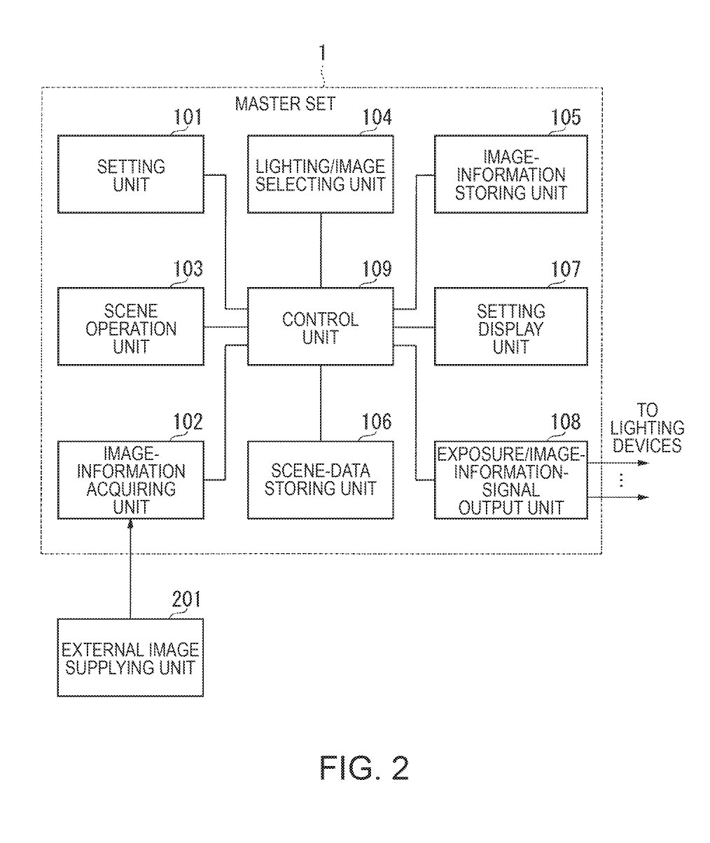

FIG. 2 is a block diagram showing a schematic configuration example of a master set 1 according to the embodiment of the invention.

The master set 1 according to this embodiment includes a setting unit 101, an image-information acquiring unit 102, a scene operation unit 103, a lighting/image selecting unit 104, an image-information storing unit 105, a scene-data storing unit 106, a display unit 107, an exposure/image-information-signal output unit 108, and a control unit 109.

In this embodiment, functions of a lighting controller are realized by the processing units 101 to 109. The functions of the lighting controller are collected in, for example, a predetermined box (a control box).

An external image supplying unit 201 provided on the outside of the master set 1 is shown in FIG. 2.

An example of the operation in the master set 1 according to this embodiment is explained.

The setting unit 101 includes an operation unit operated by a user. Various kinds of setting are performed in the setting unit 101 according to the operation of the operation unit by the user. Specifically, the setting unit 101 has a function of selecting (designating) one or more lighting devices among the plurality of lighting devices 11-1 to 11-N, a function of setting, for the selected lighting devices, conditions concerning lighting (lighting conditions) such as a degree of lighting (e.g., a light amount), a function of setting, for the selected lighting devices (the lighting devices having the image displaying function), conditions concerning an image (image conditions) such as one or more images to be displayed.

As the operation unit of the setting unit 101, various operation units may be used. For example, a key, a mouse, a bar, and a switch can be used. Further, as the operation unit of the setting unit 101, for example, a liquid crystal screen having a function of a touch panel can be used.

As the lighting conditions, conditions of one or more various items may be used. For example, only a condition of an item of a light amount may be used or conditions of arbitrary two or more items may be used.

As the image conditions, conditions of one or more various items may be used. For example, only a condition of an item of one or more images to be displayed may be used or conditions of arbitrary two or more items may be used.

As the images, various images may be used. For example, only images representing contents of a program such as images of a television, images of a video, and images of a planetarium do not always have to be used. As another example, images expressing tints, images expressing scenery, images expressing a wave in environmental light, and the like may be used.

As the images, for example, still images may be used or moving images (videos) may be used.

The setting display unit 107 displays, on a screen, information indicating the lighting devices selected by the setting unit 101 and information indicating the lighting conditions and the image conditions set by the setting unit 101.

The setting display unit 107 may display, as information for assisting the user in operating the operation unit of the setting unit 101 to select lighting devices, information indicating the lighting devices 11-1 to 11-N that can be selected. The setting display unit 107 may display, as information for assisting the user in operating the operation unit of the setting unit 101 to set lighting conditions and image condition, information indicating items of lighting conditions and items of image conditions that can be set (e.g., selected).

As the information displayed by the setting display unit 107, various kinds of information may be used.

As an example, according to an up or down position of an up-down movable bar included in the operation unit of the setting unit 101, the control unit 109 displays, as a bar, a light amount of lighting or the like corresponding to the position on the screen of the setting display unit 107 (or a screen of the setting unit 101). The user can set a light amount of lighting or the like by moving the bar up and down to adjust the position of the bar while looking at the display and, when a desired light amount of lighting or the like (e.g., a light amount suitable for a scene) is displayed, operating a button or the like for instructing determination.

As an example, every time a switch or the like included in the operation unit of the setting unit 101 is operated, the control unit 109 sequentially changes and displays currently-selected images on the screen of the setting display unit 107 (or the screen of the setting unit 101). The user can set an image to be displayed or the like by operating the switch to change the currently-selected images while looking at the display and, when a desired image (e.g. an image suitable for a scene) is displayed, operating a button or the like for instructing determination.

In this embodiment, both of the setting concerning lighting and the setting concerning an image are performed by the common setting unit 101. However, as another configuration example, separate setting units may be respectively provided for the setting concerning lighting and the setting concerning an image.

In this embodiment, both of the display of information concerning lighting and the display of information concerning an image are performed by the common setting display unit 107. However, as another configuration example, separate display units may be respectively provided for the display of information concerning lighting and the display of information concerning an image.

The image-information acquiring unit 102 receives and acquires information concerning an image from the external image supplying unit 201.

As the external image supplying unit 201, various operation units may be used. For example, a wired network, a wireless network, a storage device (a memory), a portable terminal such as a tablet computer, and a cellular phone can be used.

The image-information storing unit 105 stores the information concerning an image acquired by the image-information acquiring unit 102. The image-information storing unit 105 is configured using, for example, a memory.

The scene operation unit 103 includes an operation unit operated by the user. According to the operation of the operation unit by the user, the scene operation unit 103 selects one scene out of a plurality of different scenes (e.g., a scene 1, a scene 2, a scene 3, and the like identified by numbers).

As the operation unit of the scene operation unit 103, various operation units may be used. For example, a key, a mouse, a bar, and a switch can be used. As an example, as the operation unit of the scene operation unit 103, ON/OFF buttons (scene buttons) respectively corresponding to the plurality of different scenes can be used. When one ON/OFF button is switched to ON, the other ON/OFF buttons are switched to OFF.

The lighting/image selecting unit 104 can select one mode among “only lighting”, “only an image”, or “link”.

In the mode of “only lighting”, concerning irradiation of lighting and display of an image, only the irradiation of lighting is executed by the plurality of lighting devices 11-1 to 11-N. That is, the display of an image is not performed.

In the mode of “only an image”, concerning the irradiation of lighting and the display of an image, only the display of an image is executed by the plurality of lighting devices 11-1 to 11-N (having the image displaying function). That is, the irradiation of lighting is not performed.

In the mode of “link”, concerning the irradiation of lighting and the display of an image, the irradiation of lighting and the display of an image are executed by the plurality of lighting devices 11-1 to 11-N (concerning the display of an image, having the image displaying function).

As the lighting/image selecting unit 104, various operation units may be used. For example, a key, a mouse, a bar, and a switch can be used.

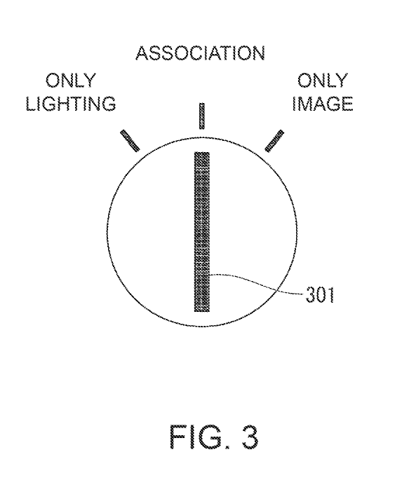

FIG. 3 is a diagram showing a schematic configuration example of a changeover switch included in the lighting/image selecting unit 104 according to the embodiment of the invention. The user holds a dial 301 and rotates the changeover switch, whereby the changeover switch is switched to select one of the modes “only lighting”, “only an image”, and “link”.

As the changeover switch, for example, one changeover switch may be arranged for each of scenes (as an example, each of scene buttons) or may be arranged in common to all the scenes (as an example, all the scene buttons).

The changeover switch is arranged, for example, in a control box (in a lighting controller).

The scene-data storing unit 106 stores data (scene data) for realizing lighting irradiation and image display respectively corresponding to a plurality of different scenes in association with each of the scenes.

In this embodiment, the scene data corresponding to the identification information of the scenes includes information concerning lighting devices that execute the lighting irradiation and lighting conditions for the lighting devices and information concerning lighting devices that execute the image display and image conditions for the lighting devices. That is, in this embodiment, the scene data specifies by which lighting device and under which lighting conditions the lighting irradiation is executed and by which lighting device (having the image displaying function) and under which image conditions the image display is executed in a scene corresponding to the scene data.

Both of the lighting irradiation and the image display may be performed by the same lighting device.

According to the scenes, for example, the lighting device that does not perform the lighting irradiation may be present, the lighting device (having the image displaying function) that does not perform the image display may be present, and the lighting device (having the image displaying function) that does not perform either the lighting irradiation or the image display may be present.

The exposure/image-information-signal output unit 108 transmits an exposure signal and an image information signal to each of the plurality of lighting devices 11-1 to 11-N. The image information signal does not have to be sent to the lighting device not having the image displaying function.

The exposure signal is a signal for designating lighting conditions (e.g., a light amount) to the lighting devices. The exposure signal may be imparted with a function of controlling ON and OFF of irradiation of lighting in the lighting devices.

The image information signal is a signal for designating image conditions (e.g., information concerning an image to be displayed) to the lighting devices. The image information signal may be imparted with a function of controlling ON and OFF of display of images in the lighting devices.

In this embodiment, information concerning an image to be displayed is output (transmitted) from the master set 1 to the lighting devices (having the image displaying function). However, as another configuration example, it is also possible to store information concerning an image in storing units (e.g., memories) of the lighting devices (having the image displaying function) and output (transmit) information for identifying information concerning an image to be displayed from the master set 1 to the lighting devices to cause the lighting devices to display the information concerning the image.

The control unit 109 performs various kinds of control in the master set 1 and controls processing performed by the other processing units 101 to 108.

For example, the control unit 109 controls display of contents set by the setting unit 101 on the screen of the setting display unit 107, storage of image information acquired by the image-information acquiring unit 102 in the image-information storing unit 105, and storage of scene data for each of scenes set by the setting unit 101 and the scene operation unit 103 in the scene-data storing unit 106.

For example, the control unit 109 reads out scene data corresponding to a scene selected by the scene operation unit 103 from the scene-data storing unit 106 and outputs an exposure signal and an image information signal for realizing contents of the read-out scene data from the exposure/image-information-signal output unit 108. In this case, according to necessity, the control unit 109 reads out, from the image-information storing unit 105, image information output from the exposure/image-information-signal output unit 108.

For example, the control unit 109 controls the lighting irradiation and the image display in the plurality of lighting devices 11-1 to 11-N according to a mode selected by the lighting/image selecting unit 104.

Specifically, when the mode “link” is selected by the lighting/image selecting unit 104, for example, the control unit 109 outputs, from the exposure/image-information-signal output unit 108, an exposure signal and an image information signal for realizing the contents of the scene data corresponding to the scene selected by the scene operation unit 103.

When the mode “only lighting” is selected by the lighting/image selecting unit 104, for example, the control unit 109 outputs, from the exposure/image-information-signal output unit 108, an exposure signal (an image information signal does not have to be output) for realizing only lighting irradiation of contents of scene data corresponding to a screen selected by the scene operation unit 103.

When the mode “only an image” is selected by the lighting/image selecting unit 104, for example, the control unit 109 outputs, from the exposure/image-information-signal output unit 108, an image information signal (an exposure signal does not have to be output) for realizing only image display of the contents of the scene data corresponding to the scene selected by the scene operation unit 103.

When the mode “only lighting” is selected by the lighting/image selecting unit 104 and the control unit 109 realizes only the lighting irradiation of the contents of the scene data corresponding to the scene selected by the scene operation unit 103, for example, lighting conditions different from lighting conditions specified by the contents of the scene data may be used. As an example, different lighting conditions set in advance may be used. As another example, lighting conditions of a result obtained by applying a change set in advance (e.g., a predetermined multiplication) to the lighting conditions (e.g., a light amount) specified by the contents of the scene data may be used.

When the mode “only an image” is selected by the lighting/image selecting unit 104 and the control unit 109 realizes only the image display of the contents of the scene data corresponding to the scene selected by the scene operation unit 103, for example, image conditions different from image conditions specified by the contents of the scene data may be used. As an example, different image conditions set in advance may be used. As another example, image conditions of a result obtained by applying a change set in advance (e.g., addition or deletion of an image to be displayed) to image conditions (e.g., an image to be displayed) specified by the contents of the scene data may be used.

For example, power line communication can also be used for communication (delivery) of an image from the exposure/image-information-signal output unit 108 to the lighting devices 11-1 to 11-N. When the technique of the power line communication is used, it is possible to perform data communication without carrying out new wiring or another kind of wiring work. In this case, a signal of communication data (an image information signal representing data of an image) is delivered to all the lighting devices 11-1 to 11-N. However, the signal is only noise for the lighting devices not including a modem (e.g., the lighting devices not having the image displaying function). Modems are mounted on the lighting devices having the image displaying function. The lighting devices can project (display) an image by converting the received signal (the image information signal) into image data. For example, concerning the lighting devices having the image displaying function but not performing image projection (image display), data communication can be stopped by disabling a modem in the control box.

Radio communication can be used instead of the power line communication. For example, if a radio communication function is mounted in the control box, the lighting devices having the image displaying function can perform communication of an image using the radio communication function. In this case, to stop the delivery of the image, for example, the radio communication function in the control box is disabled.

An example of a procedure of processing for performing scene setting in the master set 1 according to this embodiment is explained.

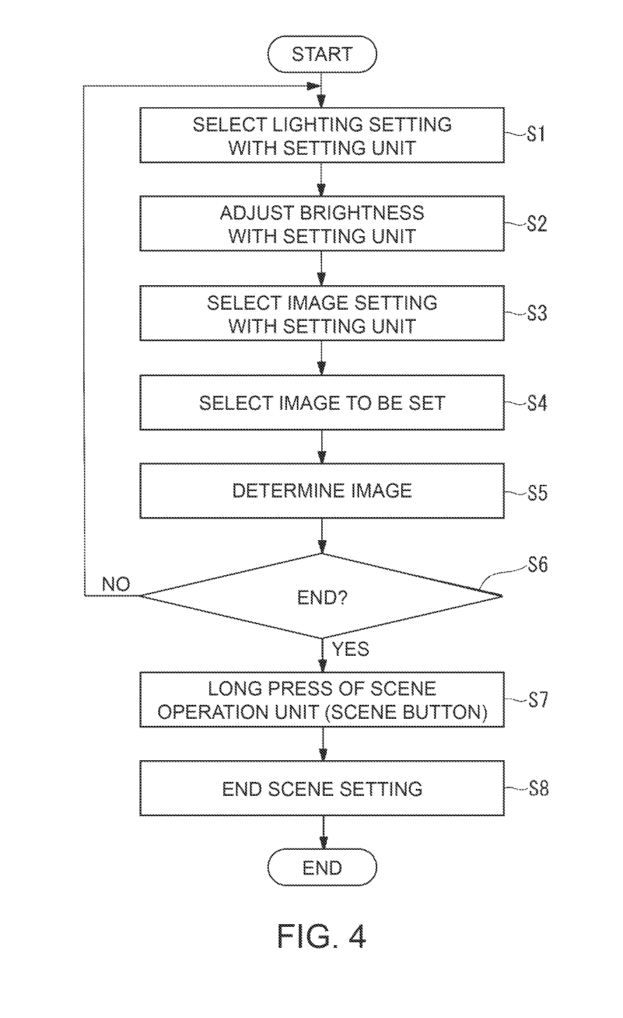

FIG. 4 is a flowchart for explaining the example of the procedure of the processing for performing scene setting in the master set 1 according to the embodiment of the invention.

First, the user operates the operation unit of the setting unit 101 to select one or more lighting devices to be subjected to setting out of the plurality of lighting devices 11-1 to 11-N. The user operates the operation unit of the setting unit 101 to select a title “lighting setting” (step S1).

Subsequently, in processing of “lighting setting”, the user operates the operation unit of the setting unit 101 to perform setting of lighting conditions concerning the lighting devices selected to be subjected to setting. In this embodiment, as the setting of the lighting conditions, adjustment of brightness (adjustment of a light amount (dimming)) is performed (step S2).

The user operates the operation unit of the setting unit 101 and selects a title “image setting” (step S3).

In processing of “image setting”, the user operates the operation unit of the setting unit 101 and performs setting of image conditions concerning the lighting devices selected to be subjected to the setting. In this embodiment, as the setting of image conditions, the user selects an image to be displayed (step S4) and determines the image to be displayed (decides the selected image) (step S5).

When the user continues the setting of lighting conditions and image conditions concerning the lighting devices (step S6), the user returns to the processing for selecting the lighting devices to be subjected to setting and performs the same setting processing (step S1 to S5).

On the other hand, when the user ends the setting of lighting conditions and image conditions concerning the lighting devices and decides and registers scenes of the lighting conditions and the image conditions currently set concerning the plurality of lighting devices 11-1 to 11-N (step S6), the user operates the scene operation unit 103 and selects and determines a scene to be registered. In this embodiment, as processing for selecting and determining a scene to be registered, the user performs a long press (e.g., a press for a predetermined time such as one second) of a scene button corresponding to a scene to be registered (e.g., any one scene identified by a number) among a plurality of scene buttons corresponding to each of scenes (step S7).

Consequently, the scene of the lighting conditions and the image conditions currently set concerning the plurality of lighting devices 11-1 to 11-N is registered in the scene determined to be registered (e.g., any one scene identified by a number) (step S8).

The registration is performed by the control unit 109 storing scene data for specifying registration contents in the scene-data storing unit 106.

Thereafter, when the user operates the scene operation unit 103 and selects the scene, the control unit 109 controls lighting irradiation and image display (e.g., image display in only the lighting devices having the image displaying function) for each of the plurality of lighting devices 11-1 to 11-N via the exposure/image-information-signal output unit 108 such that lighting irradiation under the lighting conditions registered in the scene image and image display under the image conditions registered in the scene are realized.

In this embodiment, the user performs a press (a short press rather than the long press) of a scene button corresponding to a desired scene to select the scene. When the user presses the scene button to realize the scene corresponding to the scene button, the user can set a scene of “only lighting”, a scene of “only an image”, or a scene of “link” (both lighting and an image) by operating the lighting/image selecting unit 104 (e.g., the changeover switch shown in FIG. 3). For example, when the user desires the scene of “only lighting”, the user can reproduce the relevant scene of only illumination by setting the changeover switch to “only lighting” and pressing a desired button. The same applies concerning the scene of “only an image” and the scene of “link”.

A specific example of the processing in steps S1 to S8 is explained.

First, a menu showing buttons of “scene setting”, “lighting setting”, “image setting”, “image capturing”, “others”, and the like is displayed on the screen of the setting unit 101. The user operates the operation unit of the setting unit 101, presses the button of “scene setting”, and selects one or more lighting devices to be subjected to setting out of the plurality of lighting devices 11-1 to 11-N. The user operates the operation unit of the setting unit 101, presses the button of “lighting setting”, and sets brightness of lighting (a light amount) (step S1).

At this point, for example, buttons representing upward and downward arrows (e.g., an upward triangular button and a downward triangular button) and a bar representing a light amount are displayed on the screen of the setting unit 101 (or the screen of the setting display unit 107). When the user adjusts a light amount, the user presses the buttons representing the upward and downward arrows to increase or reduce the light amount and adjust the light amount while looking at the bar representing the light amount. At a stage when the light amount reaches a desired light amount, the user presses a button representing “determine” displayed on the screen of the setting unit 101 (or the screen of the setting display unit 107) to decide the light amount (step S2).

Subsequently, the user operates the operation unit of the setting unit 101 and presses the button of “image setting” to set an image (step S3).

At this point, for example, arrows representing up, down, left, right, and the like (arrow keys) and one image stored in the image-information storing unit 105 are displayed (or two or more images are displayed as a list) on the screen of the setting unit 101 (or the screen of the setting display unit 107). The user presses the arrow keys, changes an image to be selected, and moves a pointer (e.g., a frame set as a mark) to a desired image (step S4). When the user presses the “determine” button displayed on the screen of the setting unit 101 (or the screen of the setting display unit 107), the selected image displayed on the screen of the setting unit 101 (or the screen of the setting display unit 107) is determined (step S5).

When the image is determined in this way, a message “please press any one of the scene buttons long” is displayed on the screen of the setting display unit 107 (or the screen of the setting unit 101) (step S6). At this point, when the user presses any one of the scene buttons long (step S7), setting of a scene is performed and a message “scene setting ends” is displayed on the screen of the setting display unit 107 (or the screen of the setting unit 101). Consequently, the setting of the scene (preparation of the scene) is completed (step S8).

In the procedure explained above (e.g., step S6), when time of non-operation by the user exceeds a predetermined time (e.g., thirty seconds), the setting is reset and the screen of the setting unit 101 and the screen of the setting display unit 107 return to the initial screens.

As explained above, the lighting system according to this embodiment includes the plurality of lighting devices 11-1 to 11-N set in the lighting space and the master set 1 configured to control, for each of sense, lighting irradiation and image display in the plurality of lighting devices 11-1 to 11-N. The master set 1 stores, in the scene-data storing unit 106, scene data for specifying lighting conditions and image conditions in the lighting devices 11-1 to 11-N that should be executed for each of a plurality of scenes. When one scene is designated, the master set 1 controls the lighting devices 11-1 to 11-N to execute lighting irradiation and image display specified by lighting conditions and image conditions of scene data corresponding to the scene.

In the lighting system according to this embodiment, at least one of the plurality of lighting devices 11-1 to 11-N is a bulb-type lighting device that has both of the lighting function and the image displaying function.

As explained above, in the lighting system according to this embodiment, it is possible to effectively control the plurality of lighting devices 11-1 to 11-N including at least one bulb-type lighting device having both of the lighting function and the image displaying function. Consequently, in this embodiment, in a lighting system of a multi-light type, it is possible to perform presentation using lighting and an image (e.g., light-up and display of an image).

For example, in the lighting system according to this embodiment, it is possible to change only conditions of lighting, change only conditions of an image, and change both the conditions of lighting and the conditions of an image according to a feeling of the user and increase options for the user. Consequently, in the lighting system according to this embodiment, it is possible to project an image matching lighting on a space using, for example, one button. The user can enjoy lighting and an image extremely easily and simply.

For example, if the lighting devices having the image displaying function are introduced into the existing lighting system (a system for only lighting irradiation) being widely used, it is possible to enjoy spatial presentation more easily, more comfortably, and more variously. Basically, if one or more lighting devices are replaced with the lighting devices having the image displaying function in the present system (the system for only lighting irradiation), it is possible to project images in various places. Consequently, as in rearrangement of a room, it is possible to readily change a place where an image is projected and realize more effective spatial presentation than in the past.

Currently, in the field of lighting in which an LED (Light Emitting Diode) is used, to make the best use of the characteristics of the LED and according to a trend for demanding energy saving measures and a comfortable space, lighting suitable for a scene of a space is started to be proposed. In view of a wide variety of lighting ranging from one lighting per one room to multiple lighting per one room is proposed, such proposal is considered to be widely infiltrated in future.

As a specific example, as display of an image, a method of dimly casting an image on a wall surface may be used, a method of projecting an image on a screen as in a theater may be used, or a method of casting an image on a floor may be used. These methods can be changed according to scenes.

For example, a plurality of lighting devices having the image displaying function are set. In a scene provided during a family fireside, the lighting device including a projector (an image displaying function) for displaying (projecting) an image on a wall surface is used. In a scene provided during mealtime, the lighting device including a projector (an image displaying function) for projecting an image on a table is used. In a scene provided during relaxation, the lighting device including a projector (an image displaying function) for projecting an image (e.g., a relax video) on a floor or a wall surface is used. In a scene in a theater time, the lighting device including a projector (an image displaying function) for projecting an image for improving a sense of presence (e.g., an auxiliary image) on a screen, a wall surface, or the like is used. In this way, it is possible to switch the projector (the image displaying function) in use according to a scene and simply add an image to the scene.

In the lighting system according to this embodiment, the lighting/image selecting unit 104 (e.g., the changeover switch shown in FIG. 3) is switched according to a state of mind of the user, for example, a state in which the user desires to live with only lighting, a state in which the user desires to relax with only an image, or a state in which the user desires both of lighting and an image. Therefore, it is possible to simply and easily realize three patterns of only lighting, only an image, and both of lighting and an image. Consequently, in the lighting system according to this embodiment, it is possible to increase options of spatial presentation from those in the past and provide the user with a comfortable living (space).

The lighting system according to this embodiment can be not only applied to a lighting system in a home but also applied to, for example, spatial presentation in a store, spatial presentation in a hotel and a Japanese-style hotel, and a spatial presentation in a restaurant. As a space to which the lighting system is applied, various spaces may be used. For example, a living room, a bedroom, a study, and a kitchen may be used.

### Explanation of a Bulb-Type Lighting Device

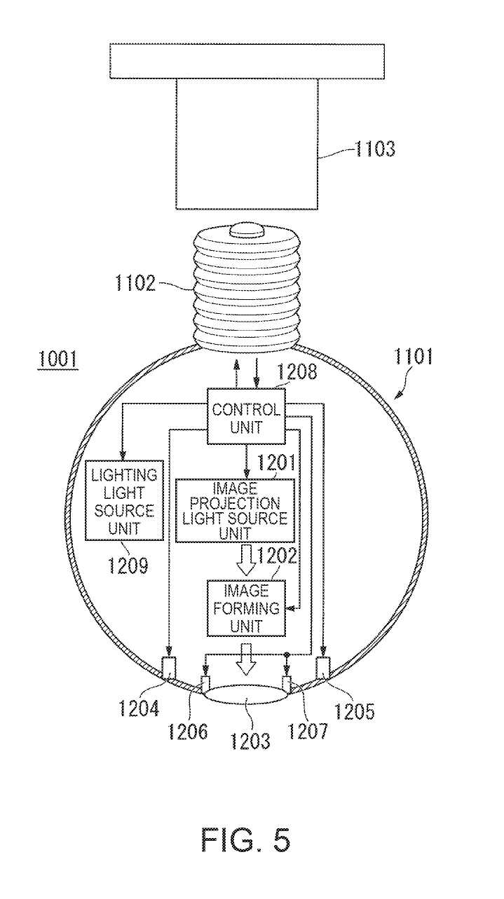

An example of a bulb-type lighting device having both of the lighting function and the image displaying function is explained with reference to FIGS. 5 to 7.

Such a bulb-type lighting device can be used as at least one of the plurality of lighting devices 11-1 to 11-N in the lighting system according to this embodiment.

The bulb-type lighting device explained with reference to FIGS. 5 to 7 is an example. A bulb-type lighting device having an exact configuration shown in the figures does not always have to be applied to the lighting system according to this embodiment. A bulb-type lighting device having a different configuration (e.g., a bulb-type lighting device obtained by removing a part of the components (the functions) from the bulb-type lighting device shown in FIGS. 5 to 7 or adding components (functions) to the bulb-type lighting device shown in FIGS. 5 to 7) may be applied to the lighting system according to this embodiment.

FIG. 5 is a diagram schematically showing a configuration example of a bulb-type lighting device 1001 having both of the lighting function and the image displaying function (in this embodiment, an image projecting function).

The lighting device 1001 includes a lighting device main body 1101 and a connecting unit 1102 for connecting the lighting device main body 1101 to an existing lighting device fitting 1103 (e.g., a receptacle for bulb attachment or a socket for bulb attachment).

The lighting device main body 1101 includes a light source unit for image projection (an image projection light source unit) 1201, an image forming unit 1202, a lens 1203 configured to project an image formed by the image forming unit 1202 on a projection surface, a distance measuring unit 1204 capable of measuring a distance from the lighting device main body 1101 to the projection surface, an image pickup unit 1205 capable of picking up an image of a state of an instruction action performed by a user, two electrodes 1206 and 1207 for applying a voltage to the lens 1203, a control unit 1208, and a light source unit for lighting (a lighting light source unit) 1209.

In FIG. 5, arrows represented by solid lines indicate a flow of an electric signal and arrows represented by white voids indicate progress of light.

The connecting unit 1102 is the same as a cap provided in, for example, an incandescent light bulb, a bulb-type fluorescent lamp, and a bulb-type LED lamp. Therefore, like the incandescent light bulb, the bulb-type fluorescent lamp, the bulb-type LED lamp, and the like, the lighting device 1001 is connected to the lighting device fitting 1103 by screwing the cap into the lighting device fitting 1103 such as the receptacle for bulb attachment or the socket for bulb attachment.

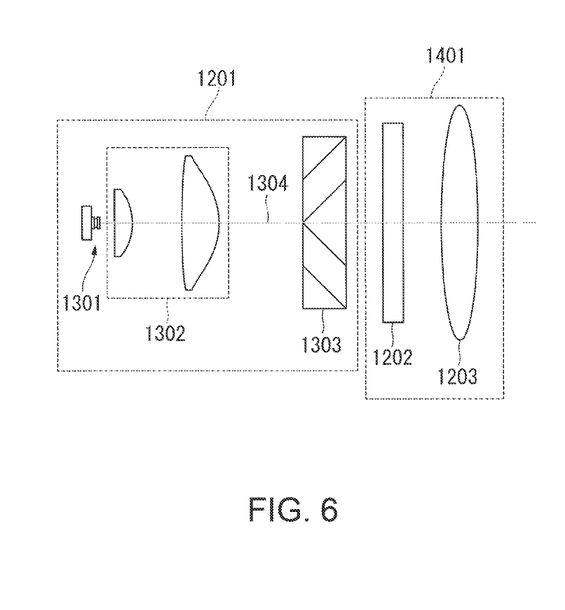

FIG. 6 is a diagram schematically showing a configuration example of an optical system related to image projection of the bulb-type lighting device 1001 having both of the lighting function and the image displaying function (in this example, the image projecting function).

The optical system related to the image projection of the lighting device 1001 includes the image projection light source unit 1201, the image forming unit 1202, and the lens 1203 used as a projection lens. In this example, a combination of the image forming unit 1202 and the lens 1203 is referred to as image projecting unit 1401.

A liquid crystal light modulating element is used as the image forming unit 1202.

The optical system of the lighting device 1001 in this example has substantially the same configuration as an optical system of a single-plate liquid crystal projector.

The image projection light source unit 1201 includes a light source 1301 (e.g., a white light emitting diode), a collimator optical system 1302, and a polarization conversion element 1303.

The light source 1301 emits light including red light, green light, and blue light. The light source 1301 functions as a light source of the image projecting unit 1401.

The collimator optical system 1302 is an optical element that parallelizes light emitted from the light source 1301.

The polarization conversion element 1303 is an element that subjects the light passing through the collimator optical system 1302 to polarization conversion. The polarization conversion element 1303 includes a polarization separation layer that directly transmits one linearly polarized light component among polarization components of incident light and reflects the other linearly polarized light component in a direction perpendicular to an optical axis 1304, a reflection layer that reflects the other linearly polarized light component, which is reflected by the polarization separation layer, in a direction parallel to the optical axis 1304, and a phase difference plate that converts the other linearly polarized light component, which is reflected by the reflection layer, into the one linearly polarized light component.

The image forming unit 1202 (in this example, the liquid crystal light modulating element) is a light modulating element that modulates light from the image projection light source unit 1201 according to information concerning an image to be projected and emits full-color image light.

The image forming unit 1202 includes a color filter. The color filter consists of a Bayer-array color filter including a reflective dichroic filter. The color filter has a function of a color separation optical system for separating light from the image projection light source unit 1201 into red light, green light, and blue light for each of pixels. As the color separation optical system, various optical systems may be used.

The image forming unit 1202 further includes an incident-side sheet polarizer arranged on the side of the polarization conversion element 1303 and an emission-side sheet polarizer arranged on the side of the lens 1203. Light modulation of the color lights is performed by this configuration.

The lens 1203 is a lens that expands and contracts (the thickness of the lens changes) according to the magnitude of a voltage applied to the electrodes 1206 and 1207 by the control unit 1208 and, therefore, can adjust a focal distance (focus adjustment). Such a lens is publicly known. For example, there is a lens, the thickness of which changes from 750 micrometers to 375 micrometers when a voltage of 20 volts is applied to the electrodes 1206 and 1207.

By using the lens 1203 as a projection lens, it is possible to expand and project an image formed by the image forming unit 1202 on the projection surface.

The distance measuring unit 1204 measures (detects) a distance from the lighting device main body 1101 to the projection surface and outputs data of the measured distance to the control unit 1208.

The image pickup unit 1205 is set to be capable of picking up an image of a state of an instruction action performed by the user. The image pickup unit 1205 outputs data of an image pickup result to the control unit 1208.

The lighting light source unit 1209 includes a light source that functions as a light source for lighting. The light source 1301 emits light including, for example, red light, green light, and blue light.

The control unit 1208 has a function of controlling application of a voltage to the light source 1301 of the image projection light source unit 1201, the image forming unit 1202, the lens 1203, the distance measuring unit 1204, the image pickup unit 1205, the electrodes 1206 and 1207, and the light source of the lighting light source unit 1209.

The control unit 1208 has, for example, a function of capable of acquiring information present in a Web site (a Web information acquiring function) and a communication function of capable of receiving a television broadcast and the like.

The control unit 1208 includes a storing unit.

In the lighting device 1001, the image projection light source unit 1201, the image forming unit 1202, and the lens 1203 are arranged on the same straight line.

When the lighting device 1001 is applied to the lighting system according to this embodiment, for example, the lighting device 1001 may be configured to be capable of controlling the control unit 1208 of the lighting device 1001 according to the control from the master set 1 shown in FIGS. 1 and 2. Consequently, the lighting device 1001 may be configured to be capable of controlling at least one or more of the distance measuring unit 1204, the image pickup unit 1205, and the electrodes 1206 and 1207 via the control unit 1208 of the lighting device 1001.

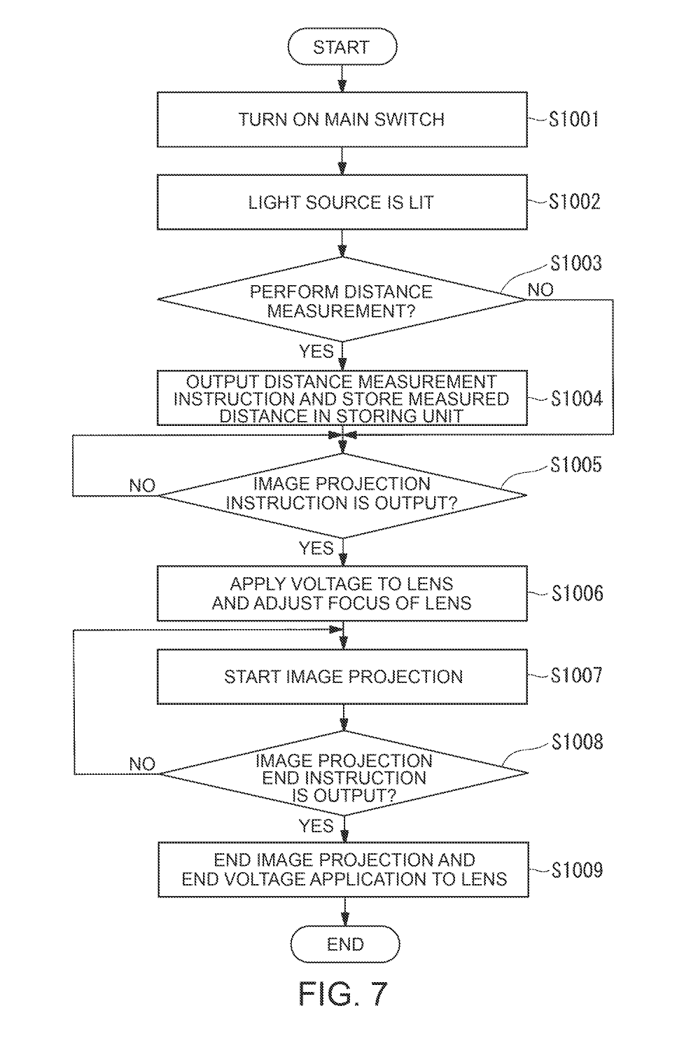

FIG. 7 is a flowchart for explaining an example of a procedure of processing performed in the bulb-type lighting device 1001 having both of the lighting function and the image displaying function (in this example, the liquid crystal light modulating element).

In the flowchart shown in FIG. 7, an operation performed by the control unit 1208 of the lighting device 1001 is mainly explained. However, the operation of the lighting device 1001 performed by the user is also included in the flowchart.

When a main switch is turned on (step S1001), the light source 1301 of the image projection light source unit 1201 is lit and the light source of the lighting light source unit 1209 is lit (step S1002). For example, a switch for turning on and off the lighting of the light source 1301 of the image projection light source unit 1201 (a main switch for image projection) and a switch for turning on and off the lighting of the light source of the lighting light source unit 1209 (a main switch for lighting) may be separately provided.

States of ON and OFF of the main switch can be switched by, for example, the operation or the action by the user. When the lighting device 1001 is applied to the lighting system according to this embodiment, for example, the lighting device 1001 may be configured to be capable of changing the states of ON and OFF of the main switch of the lighting device 1001 according to the control from the master set 1 shown in FIGS. 1 and 2.

In the lighting device 1001, when the control unit 1208 senses (detects) that the light source 1301 is lit, at this stage, the control unit 1208 performs control for projecting a white image. Consequently, irradiation by white light without presence of an image within a projection range of an image is performed.

At this point, the lighting device 1001 functions as a lighting device for lighting.

In this example, the lighting device 1001 is configured to actuate only the lighting function and stop the image displaying function immediately after the main switch of the lighting device 1001 is switched from OFF to ON. However, as another configuration example, the lighting device 1001 may be configured to actuate both of the lighting function and the image displaying function according to necessity from the time immediately after the main switch of the lighting device 1001 is switched from OFF to ON.

In a state in which the lighting device 1001 functions as the lighting device for lighting, the control unit 1208 determines whether measurement of a distance to the projection surface is performed (step S1003). When determining that the measurement of the distance is performed, the control unit 1208 outputs an instruction for the distance measurement to the distance measuring unit 1204 and stores data of the distance measured by the distance measuring unit 1204 in a storing unit (not shown in the figure) (step S1004). The control unit 1208 changes to a state of a wait for an image projection start instruction and determines whether the image projection start instruction is output in the state of the wait for the image projection start instruction (step S1005).

In step S1003, the control unit 1208 determines whether the distance measurement is performed. This is because, when the distance between the lighting device main body 1101 and the projection surface is fixed, once the distance measurement is carried out, it is possible to omit the distance measurement thereafter. In this case, the control unit 1208 can determine whether the distance measurement is performed according to, for example, whether measured distance data is stored in the storing unit. The distance measurement is not performed when measured distance data is stored in the storing unit. The distance measurement is performed when measured distance data is not stored in the storing unit.

Such distance data may be fixedly stored in the storing unit in advance.

When determining in the processing in step S1003 that the distance measurement is not performed, the control unit 1208 shifts to the processing in step S1005 without outputting an instruction for the distance measurement to the distance measuring unit 1204.

When a predetermined image projection start instruction is output in the processing in step S1005, the control unit 1208 applies a predetermined voltage to the lens 1203 and performs focus adjustment for the lens 1203 on the basis of the distance data stored in the storing unit (step S1006) and starts projection (display) of an image (step S1007). The image projected within the projection range is subjected to the focus adjustment by the lens 1203 according to the distance to the projection surface. Therefore, for example, the image is a clear image (or an image subjected to desired focus adjustment like an intentionally blurred image).

The predetermined image projection start instruction can be switched according to, for example, the operation or the action by the user. When the lighting device 1001 is applied to the lighting system according to this embodiment, for example, the lighting device 1001 is configured to be capable of outputting the predetermined image projection start instruction according to the control from the master set 1 shown in FIGS. 1 and 2.

When the image projection start instruction is output according to the action by the user, the user performs a predetermined action (gesture) under the lighting device main body 1101 to thereby output the image projection start instruction. For example, the user performs an action of, for example, waving the hand of the user to the left and right twice. An image of a state of such an action performed by the user is picked up by the image pickup unit 1205. Data of the picked-up image is sent to the control unit 1208. The control unit 1208 determines, on the basis of the picked-up image data, what kind of action the user has performed and performs control corresponding to a result of the determination. Such a control can be realized by, for example, associating an instruction action performed by the user with contents to be controlled.

In the state in which the lighting device 1001 functions as the lighting device for image projection, the control unit 1208 changes to a state of a wait for a predetermined image projection end instruction and determines whether an image projection end instruction is output (step S1008).

Like the predetermined image projection start instruction, the predetermined image projection end instruction can be switched according to the operation or the action by the user. When the lighting device 1001 is applied to the lighting system according to this embodiment, for example, the lighting device 1001 is configured to be capable of outputting the predetermined image projection end instruction according to the control from the master set 1 shown in FIGS. 1 and 2.

When determining in the processing in step S1008 that the predetermined image projection end instruction is output, the control unit 1208 ends the image projection and ends the voltage application to the lens 1203 (step S1009). Consequently, the lighting device 1001 functions as the lighting device for lighting.

In the flowchart of FIG. 7, the example of the procedure of the processing of the lighting device 1001 operating as the lighting function and then starting the operation as the image projecting function and ending the operation is explained. As a method of causing the lighting device 1001 to operate as the lighting function and the image projecting function, various forms may be used.

As a specific example, when the lighting device 1001 is applied to the lighting system according to this embodiment, the lighting irradiation and the image projection (the image display) in the lighting device 1001 are controlled according to the control from the master set 1 shown in FIGS. 1 and 2. For example, it is possible to cause the lighting device 1001 to perform only the lighting irradiation under predetermined lighting conditions, cause the lighting device 1001 to execute only the image projection under predetermined image conditions, or cause the lighting device 1001 to execute both of the lighting irradiation and the image projection under the predetermined lighting conditions and the predetermined image conditions.

As explained above, the lighting device 1001 shown in FIGS. 5 and 6 has the lighting function and the image projecting function (the image displaying function) and includes the lighting light source unit 1209 functioning as the light source for lighting, the image projection light source unit 1201 functioning as the light source for image projection, the image forming unit 1202 configured to modulate light from the image projection light source unit 1201 on the basis of image information for image projection and form image light, the lens 1203 configured to project the image light formed by the image forming unit 1202 on the projection surface, the image projection light source unit 1201, the control unit 1208 configured to control, the image projection light source unit 1201, the lighting light source unit 1209, and the image forming unit 1202, and the connecting unit 1102 that can be electrically connected to a lighting device fitting (e.g., an existing lighting device fitting).

In this way, in the lighting device 1001 shown in FIGS. 5 and 6, the image projecting unit 1401 (the image forming unit 1202 and the lens 1203) is built in the lighting device main body 1101. Therefore, it is possible to configure a lighting device having the lighting function and the image projecting function irrespective of presence or absence of a globe or the like. Therefore, for example, it is possible to reduce limitations on types of lighting devices that can be applied as the lighting device having the image projecting function.

The lighting device 1001 includes, for example, the connecting unit 1102 that can be electrically connected to the existing lighting device fitting. Therefore, it is possible to attach the lighting device 1001 in the same manner as attaching an incandescent light bulb, a bulb-type fluorescent lamp, a bulb-type LED lamp, and the like. Therefore, a general user can easily attach the lighting device 1001 in a desired place without relying on a professional.

In the lighting device 1001, the lens 1203 that can perform focus adjustment according to the application of a voltage is used. It is possible to perform the focus adjustment by applying a voltage corresponding to the distance to the projection surface. Therefore, when the lighting device 1001 is used as the lighting device for image projection, it is possible to (e.g., automatically) perform adjustment for changing an image projected on the projection surface to a clearer image (or other focus-adjusted images).

As another configuration example, the lighting device 1001 may include a sound output unit configured to output sound. The sound output unit is configured by using, for example, a speaker. For example, when an image involving sound is projected by the image projecting function, it is possible to simultaneously output the sound or output only the sound using the sound output unit.

As another configuration example, as the type, the shape, and the like of the lighting device main body 1101, various types, shapes, and the like may be used. For example, as the shape, besides a spherical shape, shapes such as a cylindrical shape and a rectangular parallelepiped may be used.

As another configuration example, the lighting device 1001 may be attached to a wall, a pillar, and the like besides the ceiling. The lighting device 1001 may be configured as, for example, a handy light. In this case, the connecting unit 1102 is adapted to a socket for bulb attachment of the handy light.

The lighting device 1001 shown in FIGS. 5 and 6 is attached to the lighting device fitting 1103 directly attached to the ceiling. However, as another configuration example, when a lighting device fitting (e.g., a bulb socket) is suspended from the ceiling by a connection cord, the lighting device 1001 is attached to the lighting device fitting.

In the lighting device 1001 shown in FIGS. 5 and 6, the fitting (e.g., a screwed-type cap) connectable to a receptacle for bulb attachment or a socket for bulb attachment is used as the connecting unit 1102. However, as another configuration example, when a hook sealing or a hook rosette is attached to the ceiling or the like as the lighting device fitting, a fitting connectable to the hook sealing or the hook rosette may be used. In this case, for example, a connection cord is led out from the lighting device main body 1101. The fitting connectable to the hook sealing or the hook rosette is attached to the distal end of the connection cord.

As another configuration example, as the light modulating element in the image forming unit 1202, besides the liquid crystal light modulating element, a digital micro-mirror device may be used.

As another configuration example, when the lighting device 1001 functions as the lighting device for lighting, besides forming a white image using the liquid crystal light modulating element and projecting the white image from the image projecting unit 1401, the liquid crystal light modulating element may be kept transparent (may remain transparent without generating an image). The liquid crystal light modulating element may mechanically avoid the image projection light source unit 1201. With this configuration, it is possible to efficiently obtain predetermined brightness.

In the lighting device 1001 shown in FIGS. 5 and 6, as the focus adjustment, a voltage is applied to the electrodes of the lens 1203 to control the thickness of the lens 1203. However, as another configuration example, a lens of a screw type may be used to manually perform the focus adjustment. With this configuration, for example, it is possible to reduce the number of components, further simplify the lighting device, and further realize a reduction in weight.

As another configuration example, in the lighting device 1001, for example, a configuration not including at least one or more of the distance measuring unit 1204, the image pickup unit 1205, and a lens unit (the lens 1203 and the electrodes 1206 and 1207) that can perform focus adjustment (and the function of the control unit 1208 related to these units) may be used.

As another configuration example, the lighting device 1001 may include, for example, a partition region (a partition wall section) that partitions a portion of a space including the lighting light source unit 1209 and a portion of a space including the image projection light source unit 1201, the image forming unit 1202, and the lens 1203.

As another configuration example, in the lighting device 1001, a configuration including a processing unit not explained above (and a function of the control unit 1208 related to the processing unit) may be used.

### Explanation of a Bulb-Type Lighting Device Including the Lighting Light Source Unit and the Image Projection Light Source Unit as a Common Light Source

In FIGS. 5 to 7, the lighting device (e.g., the bulb-type lighting device) including the lighting light source and the image projection (image display) light source as the separate light sources is applied to the lighting system according to this embodiment. However, as another configuration example, a lighting device (e.g., a bulb-type lighting device) including the lighting light source and the image projection (image display) light source as a common light source can also be applied to the lighting system according to this embodiment.

As a configuration example, in the configuration shown in FIG. 5, it is possible to use the image projection light source unit (in this configuration example, simply referred to as light source unit) 1201 for both the lighting and the image projection (the image display) without providing the lighting light source unit 1209.

In this case, in the lighting device 1001, the light source 1301 of the light source unit 1201 functions as the lighting light source and functions as the image projection light source. Therefore, it is unnecessary to separately provide the lighting light source and the image projection light source. It is possible to simplify the configuration and realize a reduction in weight.

For example, when the lighting device 1001 functions as the lighting device for lighting, a white image is projected from the image projecting unit 1401.

Concerning the processing in step S1002 in the flowchart of FIG. 7, in the lighting device 1001, when the control unit 1208 senses (detects) that the light source 1301 is lit, at this stage, the control unit 1208 performs control for projecting a white image. Consequently, lighting by white light without presence of an image within a projection range of lighting is performed. This state is a state in which the lighting device 1001 functions as the lighting device for lighting.

In this example, the lighting device 1001 is configured to actuate only the lighting function and stop the image displaying function immediately after the main switch of the lighting device 1001 is switched from OFF to ON. However, as another configuration example, the lighting device 1001 may be configured to actuate the image displaying function according to necessity from the time immediately after the main switch of the lighting device 1001 is switched from OFF to ON.

The focus adjustment of the lens 1203 can be used not only when the lighting device 1001 projects an image but also when the lighting device 1001 is used as lighting. For example, the focus adjustment of the lens 1203 is performed such that light for lighting spreads to as wide a range as possible (light diffuses), light irradiated from the lighting device main body 1101 can irradiate a range wider than a standard projection range. Conversely, when the focus adjustment of the lens 1203 is performed such that the light for lighting is projected within the standard projection range, the light irradiated from the lighting device main body 1101 can be irradiated in a spotlight manner. When the lighting device 1001 is caused to function as the lighting device for lighting in this way, as in the case when the lighting device 1001 is caused to function as the lighting device for image projection, it is possible to adjust a state of spread of the light for lighting, uniformity of the light, and the like by performing the focus adjustment of the lens 1203.

In the flowchart of FIG. 7, in the state in which the lighting device 1001 functions as the lighting device for lighting, the control unit 1208 determines whether measurement of a distance to the projection surface is performed (step S1003). When determining that the measurement of the distance is performed, the control unit 1208 outputs an instruction for the distance measurement to the distance measuring unit 1204 and stores data of the distance measured by the distance measuring unit 1204 in a storing unit (not shown in the figure) (step S1004). The control unit 1208 changes to a state of a wait for an image projection start instruction and determines whether the image projection start instruction is output in the state of the wait for the image projection start instruction (step S1005).

Concerning the other parts of the flowchart of FIG. 7, for example, it is possible to use processing same as the processing performed in the case of the bulb-type lighting device separately including the lighting light source unit 1209 and the image projection light source unit 1201.

### Configuration Example According to the Embodiment Explained Above

As a configuration example, there is provided the lighting system including: the master set 1; and the plurality of lighting devices 11-1 to 11-N controlled by the master set 1. At least one of the plurality of lighting devices 11-1 to 11-N is the bulb-type lighting device 1001 having the lighting function and the image displaying function and including: the light source for lighting and the light source for image display provided in common or separately (in the example shown in FIGS. 5 and 6, the common light source 1301); the image forming unit 1202 configured to modulate light from the light source for image display on the basis of image information for image display and form image light; the lens 1203 configured to project the image light formed by the image forming unit 1202 on the projection surface; and the connecting unit 1102 electrically connectable to the lighting device fitting 1103.

As a configuration example, in the lighting system, the master set 1 includes: the scene-data storing unit 106 configured to store, for each of a plurality of scenes, scene data that is data for defining a condition concerning lighting irradiation and a condition concerning image display in each of the plurality of lighting devices 11-1 to 11-N; the scene operation unit 103 operated by the user to receive designation of any one scene among the plurality of scenes; and the control unit 109 configured to control each of the plurality of lighting devices 11-1 to 11-N on the basis of the condition concerning the lighting irradiation and the condition concerning the image display defined by the scene data stored in the scene-data storing unit 106 in association with the scene designated by the scene operation unit 103.

As a configuration example, in the lighting system, the master set 1 includes the setting unit 101 operated by the user to set, for each of a plurality of scenes, a condition concerning lighting irradiation and a condition concerning image display in each of the plurality of lighting devices 11-1 to 11-N defined by scene data that is data for defining a condition concerning lighting irradiation and a condition concerning image display in each of the plurality of lighting devices 11-1 to 11-N.

As a configuration example, in the lighting system, the master set 1 includes the lighting/image selecting unit 104 operated by the user to select any one of only lighting, only an image, and a link of lighting and an image. The control unit 109 controls the plurality of lighting devices 11-1 to 11-N to execute only lighting irradiation when the only lighting is selected by the lighting/image selecting unit 104, controls the plurality of lighting devices 11-1 to 11-N to execute only image display when the only an image is selected by the lighting/image selecting unit 104, and controls the plurality of lighting devices 11-1 to 11-N to execute the lighting irradiation and the image display when the link of lighting and an image is selected by the lighting/image selecting unit 104.

### BRIEF OF THE EMBODIMENT EXPLAINED ABOVE

The embodiment of the invention is explained above with reference to the drawings. However, specific forms are not limited to the embodiment and include designs and the like not departing from the spirit of the invention.

A computer program for realizing the functions of arbitrary components (e.g., the master set 1 and the lighting devices 11-1 to 11-N) in the lighting system explained above may be recorded in a computer-readable recording medium and read and executed by a computer system. The “computer system” includes an OS (Operating System) and hardware such as peripheral equipment. The “computer-readable recording medium” refers to portable media such as a flexible disk, a magneto-optical disk, a ROM (Read Only Memory), and a CD (Compact Disk)-ROM and a storage device such as a hard disk built in the computer system. Further, the “computer-readable recording medium” includes a medium that retains the computer program for a fixed time like a volatile memory (RAM: Random Access Memory) in a computer system that functions as a server or a client when the computer program is transmitted via a network such as the Internet or a communication line such as a telephone line.

The computer program may be transmitted from the computer system that stores the computer program in the storage device or the like to another computer system via a transmission medium or by a transmission wave in the transmission medium. The “transmission medium” for transmitting the computer program refers to a medium having a function of transmitting information like a network (a communication network) such as the Internet or a communication line (a line of communication) such as a telephone line.

The computer program may be a computer program for realizing a part of the functions explained above. Further, the computer program may be a computer program that can realize the functions in combination with a computer program already recorded in the computer system, i.e., a so-called differential file (a differential program).

What is claimed is:

1. A lighting system comprising:
a master set; and
a plurality of lighting devices controlled by the master set, wherein
at least one of the plurality of lighting devices is a bulb-type lighting device having a lighting function and an image displaying function and including:
a light source for lighting and a light source for image display provided in common or separately;
an image forming unit configured to modulate light from the light source for image display on the basis of image information for image display and form image light;
a lens configured to project the image light formed by the image forming unit on a projection surface; and
a connecting unit electrically connectable to a lighting device fitting.

2. The lighting system according to claim 1, wherein the master set includes:
a scene-data storing unit configured to store, for each of a plurality of scenes, scene data that is data for defining a condition concerning lighting irradiation and a condition concerning image display in each of the plurality of lighting devices;
a scene operation unit operated by a user to receive designation of any one scene among the plurality of scenes; and
a control unit configured to control each of the plurality of lighting devices on the basis of the condition concerning the lighting irradiation and the condition concerning the image display defined by the scene data stored in the scene-data storing unit in association with the scene designated by the scene operation unit.

3. The lighting system according to claim 1, wherein the master set includes a setting unit operated by a user to set, for each of a plurality of scenes, a condition concerning lighting irradiation and a condition concerning image display in each of the plurality of lighting devices defined by scene data that is data for defining a condition concerning lighting irradiation and a condition concerning image display in each of the plurality of lighting devices.

4. The lighting system according to claim 1, wherein
the master set includes a lighting/image selecting unit operated by a user to select any one of only lighting, only an image, and a link of lighting and an image, and
the control unit controls the plurality of lighting devices to execute only lighting irradiation when the only lighting is selected by the lighting/image selecting unit, controls the plurality of lighting devices to execute only image display when the only an image is selected by the lighting/image selecting unit, and controls the plurality of lighting devices to execute the lighting irradiation and the image display when the link of lighting and an image is selected by the lighting/image selecting unit.

5. A lighting method comprising a master set controlling a plurality of lighting devices, at least one of which is a bulb-type lighting device having a lighting function and an image displaying function and including a light source for lighting and a light source for image display provided in common or separately, an image forming unit configured to modulate light from the light source for image display on the basis of image information for image display and form image light, a lens configured to project the image light formed by the image forming unit on a projection surface, and a connecting unit electrically connectable to a lighting device fitting.

6. A lighting program for causing a computer to execute a procedure of a master set for controlling a plurality of lighting devices, at least one of which is a bulb-type lighting device having a lighting function and an image displaying function and including a light source for lighting and a light source for image display provided in common or separately, an image forming unit configured to modulate light from the light source for image display on the basis of image information for image display and form image light, a lens configured to project the image light formed by the image forming unit on a projection surface, and a connecting unit electrically connectable to a lighting device fitting.
